(19) United States
(12) Patent Application Publication
(10) Pub. No.: US 2024/0411949 A1
(43) Pub. Date: Dec. 12, 2024

(54) AUTOMATIC DESIGN DEVICE FOR XR-BASED MEP FACILITIES, AND OPERATING METHOD THEREFOR

(71) Applicants: SLZ INC., Siheung-si Gyeonggi-do (KR); Jae Heon JUNG, Seoul (KR); Yu Mi LEE, Incheon (KR)

(72) Inventors: Jae Heon JUNG, Seoul (KR); Yu Mi LEE, Incheon (KR); Tae Yang SHIN, Siheung-si (KR); Jae Sung KIM, Siheung-si (KR); Ki Sae LEE, Siheung-si (KR)

(73) Assignees: SLZ INC., Siheung-si, Gyeonggi-do (KR); Jae Heon JUNG, Seoul (KR); Yu Mi LEE, Incheon (KR)

(21) Appl. No.: 18/703,234

(22) PCT Filed: Nov. 19, 2021
(86) PCT No.: PCT/KR2021/017047

§ 371 Date: Apr. 19, 2024

(30) Foreign Application Priority Data
Oct. 22, 2021 (KR) 10-2021-014608

(51) Int. Cl. G06F 30/18; G06F 30/13; G06F 111/18; G06K 7/14

(52) U.S. Cl. CPC G06F 30/18; G06F 30/13; G06K 7/1417; G06F 2111/18

(57) ABSTRACT

Presented are an automatic design device for XR-based MEP facilities, and a method therefor, the device comprising: a position calibration unit for calibrating, to the current position of the automatic design device for XR-based MEP facilities in 3D construction site structure data, coordinates corresponding to a preset location in 3D construction site structure data including structure and coordinate information about a construction site, if the automatic design device for XR-based MEP facilities is located at the preset location of the construction site; and a location-tracking unit for tracking the location of the automatic design device for XR-based MEP facilities in the 3D construction site structure data on the basis of the current location when a user wearing the automatic design device for XR-based MEP facilities moves.

### TECHNICAL FIELD

The present invention relates to automatic design technology for extended reality (XR)-based mechanical, electrical and plumbing (MEP) facility.

### RELATED ART

Recently, in a construction site, building information modeling (BIM) data in a virtual space is generated based on three-dimensional (3D) data for the construction site and field workers are constructing mechanical, electrical and plumbing (MEP) facilities using the generated BIM data. In this case, a positional error may occur between a real construction site in which actual construction is planned and 3D data. Therefore, the field works may have the convenience of having to request a BID data producer again to correct errors, which may lead to construction delay and excessive cost. (Patent Document 1) Korean Patent Registration No. 10-2232181 (registered on Mar. 19, 2021)

### DETAILED DESCRIPTION

### Subject

Accordingly, an objective of the present invention is to provide technology for generating building information modeling (BIM) data in a construction site.

Also, an objective of the present invention is to provide position calibration technology for reducing a positional error.

### Solution

According to an aspect of the present invention, there is provided an automatic design device for extended reality (XR)-based mechanical, electrical and plumbing (MEP) facility including a communication unit configured to receive three-dimensional (3D) construction site structure data that includes structure and coordinate information of a construction site and MEP facility installation condition data that includes conditions for installing the MEP facility in the construction site: a position calibration unit configured to, when the automatic design device for XR-based MEP facility is present at a preset position of the construction site, calibrate coordinates corresponding to the preset position in the 3D construction site structure data to a current position of the automatic design device for XR-based MEP facility in the 3D construction site structure data: a position tracking unit configured to track a position of the automatic design device for XR-based MEP facility in the 3D construction site structure data based on the current position when a user wearing the automatic design device for XR-based MEP facility moves; a video capturing unit configured to capture a video that includes the construction site and a body of the user from a viewpoint of the user: a user monitoring unit configured to match the 3D construction site structure data and the video based on position tracking results and to monitor coordinates of an area indicated by the body of the user in the 3D construction site structure data; and a building information modeling (BIM) data generator configured to verify the coordinates of the area indicated by the body of the user in the 3D construction site structure data based on monitoring results in response to an input of an instruction that specifies a starting point for installing the MEP facility (hereinafter, the coordinates being referred to as starting point coordinates), to verify the coordinates of the area indicated by the body of the user in the 3D construction site structure data based on the monitoring results in response to an input of an instruction that specifies an ending point for installing the MEP facility (hereinafter, the coordinates being referred to as ending point coordinates), and to generate data for virtual MEP facility that connects the starting point coordinates and the ending point coordinates based on the MEP facility installation condition data.

In an example embodiment, when the automatic design device for XR-based MEP facility is present at the preset position of the construction site, the automatic design device for XR-based MEP facility may be configured to combine with a beacon structure installed at the preset position.

In an example embodiment, a case in which the automatic design device for XR-based MEP facility is present at the preset position of the construction site may correspond to a case in which a marker containing coordinate information corresponding to the preset position in the 3D construction site structure data in a quick response (QR) code or an image form is recognized.

In an example embodiment, the MEP facility may include at least one of pipeline, electrical cable line, communication cable line, and duct line.

In an example embodiment, the MEP facility installation condition data may include at least one of a separation distance between MEP facilities, the allowable number of inflection points, and an allowable bending angle of MEP facility.

In an example embodiment, the area indicated by the body of the user may represent an area indicated by a finger in the body of the user.

In an example embodiment, when at least one virtual MEP facility is already generated and it is impossible to generate the virtual MEP facility that connects the starting point coordinates and the ending point coordinates based on the MEP facility installation condition data while avoiding the already generated virtual MEP facility, the BIM data generator may be configured to modify data for the already generated virtual MEP facility based on the MEP facility installation condition data and to generate the data for the virtual MEP facility that connects the starting point coordinates and the ending point coordinates.

According to another aspect of the present invention, there is provided an operating method of an automatic design device for XR-based MEP facility, the method including receiving 3D construction site structure data that includes structure and coordinate information of a construction site and MEP facility installation condition data that includes conditions for installing the MEP facility in the construction site: when the automatic design device for XR-based MEP facility is present at a preset position of the construction site, calibrating coordinates corresponding to the preset position in the 3D construction site structure data to a current position of the automatic design device for XR-based MEP facility in the 3D construction site structure data; tracking a position of the automatic design device for XR-based MEP facility in the 3D construction site structure data based on the current position when a user wearing the automatic design device for XR-based MEP facility moves: capturing a video that includes the construction site and a body of the user from a viewpoint of the user: matching the 3D construction site structure data and the video based on position tracking results and monitoring coordinates of an area indicated by the body of the user in the 3D construction site structure data; verifying the coordinates of the area indicated by the body of the user in the 3D construction site structure data based on monitoring results in response to an input of an instruction that specifies a starting point for installing the MEP facility (hereinafter, the coordinates being referred to as starting point coordinates); verifying the coordinates of the area indicated by the body of the user in the 3D construction site structure data based on the monitoring results in response to an input of an instruction that specifies an ending point for installing the MEP facility (hereinafter, the coordinates being referred to as ending point coordinates); and generating data for virtual MEP facility that connects the starting point coordinates and the ending point coordinates based on the MEP facility installation condition data.

### Effect

According to example embodiments, it is possible to design building information modeling (BIM) data in a construction site.

Also, according to example embodiments, it is possible to reduce a positional error.

### BRIEF DESCRIPTION OF DRAWINGS

FIG. 1 illustrates an example of describing an automatic design device for extended reality (XR)-based mechanical, electrical and plumbing (MEP) facility according to an example embodiment.

FIG. 2 is a block diagram illustrating an automatic design device for XR-based MEP facility according to an example embodiment.

FIG. 3 illustrates an example of describing an operation of an automatic design device for XR-based MEP facility according to an example embodiment.

FIGS. 4 and 5 illustrate examples of position calibration according to an example embodiment.

FIG. 6 illustrates a video output from an automatic design device for XR-based MEP facility according to an example embodiment.

FIG. 7 is a block diagram illustrating an automatic design device for XR-based MEP facility according to another example embodiment.

### MODE

Hereinafter, various example embodiments will be described with reference to the accompanying drawings.

The example embodiments and the terms used herein are not construed to limit technology described herein to specific implementations and should be understood to include various modifications, equivalents, and/or substitutions of corresponding example embodiments.

When it is determined that detailed description related to a relevant known function or configuration may make the disclosure unnecessarily ambiguous in describing various example embodiments in the following, the detailed description will be omitted.

The following terms refer to terms defined in consideration of functions of various example embodiments and may differ depending on a user, the intent of an operator, or custom. Accordingly, the terms should be defined based on the overall contents in the present specification.

In relation to explaining drawings, like reference numerals refer to like elements.

The singular forms “a,” “an,” and “the” are intended to include the plural forms as well, unless the context clearly indicates otherwise.

Herein, expressions, such as “A or B” and “at least one of A and/or B,” may include all possible combinations of listed items.

Expressions, such as “first,” “second,” etc., may describe corresponding components regardless of order or importance and may be simply used to distinguish one component from another component and do not limit the corresponding components.

When it is described that one (e.g., first) component is “(functionally or communicatively) connected” or “accessed” to another (e.g., second) component, the component may be directly connected to the other component or may be connected thereto through still another component (e.g., third component).

Herein, “configured (or set) to ˜” may be interchangeably used with, for example, “suitable for ˜,” “having capability of ˜,” “changed to ˜,” “made to ˜,” “capable of ˜,” or “designed to ˜” in a hardware manner or a software manner, depending on situations.

In a situation, the expression “device configured to ˜” may represent that the device is “capable of” interworking with another device or parts.

For example, the phrase “processor configured (or set) to perform A, B, and C” may refer to a dedicated processor (e.g., embedded processor) for performing a corresponding operation or a general-purpose processor (e.g., central processing unit (CPU) or application processor) capable of performing corresponding operations by executing one or more software programs stored in a memory device.

Also, the term “or” represents “inclusive or” rather than “exclusive or.”

That is, unless otherwise stated or clear from the context, the expression “x uses a or b” represents any one of natural inclusive permutations.

The terms “˜unit,” “˜er/or,” etc. used in the following represent a unit of processing at least one function or operation, and may be implemented by hardware or software or combination of hardware and software.

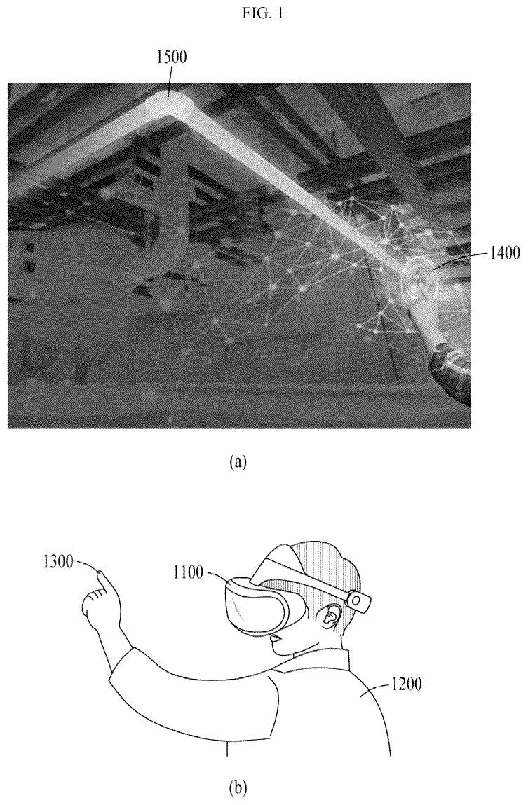

FIG. 1 illustrates an example of describing an automatic design device for XR-based mechanical, electrical and plumbing (MEP) facility according to an example embodiment.

Referring to FIG. 1, (a) of FIG. 1 illustrates a video output from an automatic design device for XR-based MEP facility 1100 and (b) of FIG. 1 illustrates an operation of a user 1200 wearing the automatic design device for XR-based MEP facility 1100 that controls the automatic design device for XR-based MEP facility 1100 to design MEP facility while viewing the video output from the automatic design device for XR-based MEP facility 1100. In detail, when the user 1200 wearing the automatic design device for XR-based MEP facility 1100 specifies a specific area 1400 of the video output from the automatic design device for XR-based MEP facility 1100 with a finger 1300, the automatic design device for XR-based MEP facility 1100 may generate a virtual MEP facility 1500 that connects the specific area 1400.

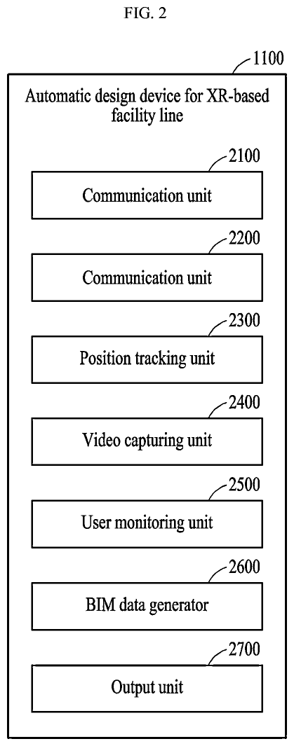

Here, output through the automatic design device for XR-based MEP facility 1100 is further described with reference to FIGS. 2 to 7.

FIG. 2 is a block diagram illustrating an automatic design device for XR-based MEP facility according to an example embodiment.

Referring to FIG. 2, the automatic design device for XR-based MEP facility 1100 may include a communication unit 2100, a calibration unit 2200, a position tracking unit 2300, a video capturing unit 2400, a user monitoring unit 2500, a building information modeling (BIM) data generator 2600, and an output unit 2700.

The communication unit 2100 may perform data communication with an external device through a wired/wireless communication method.

In an example embodiment, the communication unit 2100 may receive, from the external device, data for automatically designing the MEP facility, for example, 3D construction site structure data that includes structure and coordinate information of a construction site and MEP facility installation condition data that includes conditions for installing the MEP facility in the construction site. Here, the MEP facility may refer to facility desired to install in the construction site, such as pipeline, electrical cable line, communication cable line, duct line, and the like. The MEP facility installation condition data may represent conditions to be met in installing the MEP facility, such as a separation distance between MEP facilities, the allowable number of inflection points, and an allowable bending angle of MEP facility.

In an example embodiment, the communication unit 2100 may also receive, from the external device, software that includes an algorithm for generating virtual MEP facility based on the 3D construction site structure data and facility line condition data.

The position calibration unit 2200 may calibrate a position of the automatic design device for XR-based MEP facility 1100. In detail, when the automatic design device for XR-based MEP facility 1100 is present at a preset position of the construction site, the calibration unit 2200 may perform calibration of setting coordinates corresponding to the preset position in the 3D construction site structure data to a current position (reference position) of the automatic design device for XR-based MEP facility 1100 in the 3D construction site structure data. This is to minimize an error when installing the MEP facility by matching the position of the automatic design device for XR-based MEP facility 1100 to coordinates on the 3D construction site structure data.

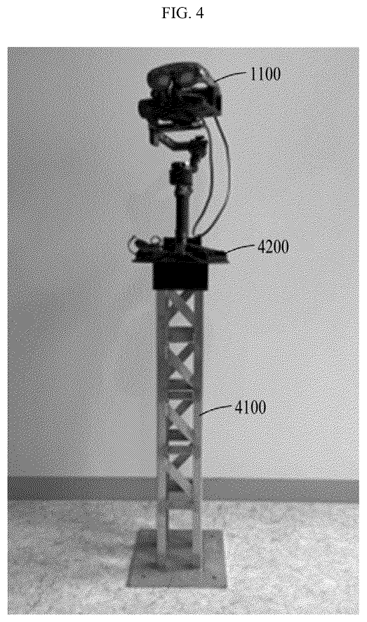

In an example embodiment, when the automatic design device for XR-based MEP facility 1100 is present at the preset position of the construction site, it may represent that the automatic design device for XR-based MEP facility 1100 is combined with a beacon structure installed at the preset position. Here, the beacon structure may include a cradle configured to couple with the automatic design device for XR-based MEP facility 1100 in its upper portion. As a specific example, referring to FIG. 4, a beacon structure 4100 may include a cradle 4200 to which the automatic design device for XR-based MEP facility 1100 couples in its upper portion.

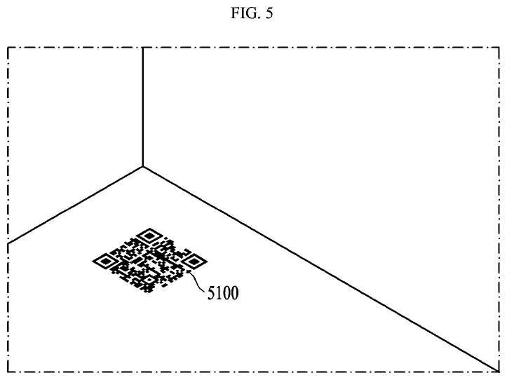

In an example embodiment, a case in which the automatic design device for XR-based MEP facility 1100 is present at the preset position of the construction site may correspond to a case in which a marker containing coordinate information corresponding to the preset position in the 3D construction site structure data in a quick response (QR) code or an image form is recognized. Here, a case in which the marker is recognized may represent that the marker is included in a video captured with a camera unit. As a specific example, referring to FIG. 5, a marker 5100 in a QR code form may be provided on an internal floor of the construction site.

The position tracking unit 2300 may track a position of the automatic design device for XR-based MEP facility 1100 on coordinates of the 3D construction site structure data. In detail, in a situation in which calibration for the position of the automatic design device for XR-based MEP facility 1100 is performed, if a user wearing the automatic design device for XR-based MEP facility 1100 moves, the position tracking unit 2300 may track the position of the automatic design device for XR-based MEP facility 1100 in the 3D construction site structure data based on a reference position. This is to update the position of the automatic design device for XR-based MEP facility 1100 in real time although the user wearing the automatic design device for XR-based MEP facility 1100 moves.

In an example embodiment, the position tracking unit 2300 may periodically or aperiodically track a position of the automatic design device for XR-based MEP facility 1100 in the 3D construction site structure data. For example, at preset time intervals or every time a movement of the user is detected, the position tracking unit 2300 may track a position of the automatic design device for XR-based MEP facility 1100 and may update position information of the automatic design device for XR-based MEP facility 1100.

The video capturing unit 2400 may capture the construction site, surroundings of the user such as a body of the user, and the like, from a viewpoint of the user wearing the automatic design device for XR-based MEP facility 1100.

The user monitoring unit 2500 may monitor the body of the user included in the video. Specifically, the user monitoring unit 2500 may verify whether the body of the user, such as a finger included in the video, includes a gesture of specifying a specific area. When the gesture of specifying the specific area is verified, the user monitoring unit 2500 may match the 3D construction site structure data and the video based on position tracking results and may verify coordinates in the 3D construction site structure data for an area indicated by the body of the user, such as the finger.

In an example embodiment, the user monitoring unit 2500 may verify an instruction from the user. In detail, when it is verified that a gesture prestored by being matched to a specific instruction is included in the video, the user monitoring unit 2500 may verify that the specific instruction is input from the user. Here, the specific instruction may include all instructions for the user to control the automatic design device for XR-based MEP facility 1100 to design the MEP facility, such as an instruction that specifies a starting point and an end point for installing the MEP facility.

The BIM data generator 2600 may generate BIM data that includes virtual design information on real MEP facility to be installed in the construction site. In detail, in response to an input of the instruction that specifies the starting point for installing the MEP facility, the BIM data generator 2600 may verify coordinates of the area indicated by the body of the user in the 3D construction site structure data based on monitoring results (hereinafter, the coordinates being referred to as starting point coordinates). In response to an input of the instruction that specifies the ending point for installing the MEP facility, the BIM data generator 2600 may verify coordinates of the area indicated by the body of the user in the 3D construction site structure data based on the monitoring results (hereinafter, the coordinates being referred to as ending point coordinates). The BIM data generator 2600 may generate the virtual MEP facility that connects the starting point coordinates and the ending point coordinates based on the MEP facility installation condition data and may store the same as the BIM data.

In an example embodiment, when at least one virtual MEP facility is already generated and it is impossible to generate the virtual MEP facility that connects the starting point coordinates and the ending point coordinates based on the MEP facility installation condition data while avoiding the already generated virtual MEP, the BIM data generator 2600 may modify data for the already generated virtual MEP facility based on the MEP facility installation condition data and may generate the data for the virtual MEP facility that connects the starting point coordinates and the ending point coordinates.

In an example embodiment, the BIM data generator 2600 may generate BIM data based on data for the MEP facility and may generate a drawing, a statement, and a design book for designing the MEP facility based on the generated BIM data.

The output unit 2700 may generate and output a video of the same view as the user's real view based on a video captured by the camera unit and, to this end, may include a display (not shown).

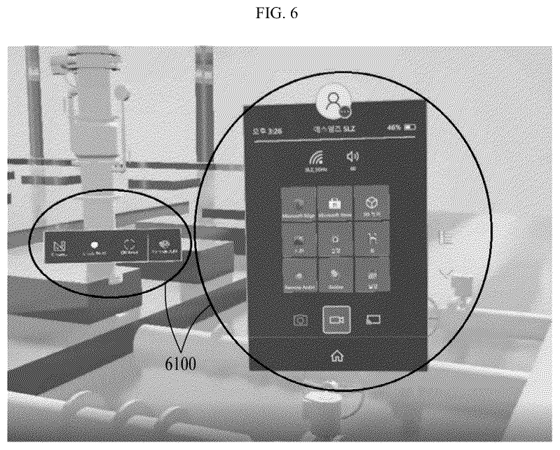

In an example embodiment, the output unit 2700 may output a video with a menu for controlling the automatic design device for XR-based MEP facility 1100, a user interface (UI) and the generated virtual MEP facility added. As a specific example, referring to FIG. 6, the menu for controlling the automatic design device for XR-based MEP facility 1100 may be added to a video output from the automatic design device for XR-based MEP facility 1100 and thereby output.

In an example embodiment, the output unit 2700 may be a display in a form of a head mounted display (HMD).

In an example embodiment, the automatic design device for XR-based MEP facility 1100 may output BIM data for a preset area. In detail, the automatic design device for XR-based MEP facility 1100 may output only BIM data for an area corresponding to the field of view of the user wearing the automatic design device for XR-based MEP facility 1100. Also, in response to a change in an area corresponding to the field of view according to a position movement and a head rotation of the user wearing the automatic design device for XR-based MEP facility 1100, the automatic design device for XR-based MEP facility 1100 may change BIM data, which is output according to the change in the field of view, to maintain continuity. This is to reduce consumption of computing resources and to improve a processing rate for processing the output BIM data by outputting only BIM data for the area corresponding to the user's field of view since the BIM data is generally large data.

Also, the automatic design device for XR-based MEP facility 1100 may further include a gyro sensor configured to detect a change in a position, an orientation, and a height according to a movement of the user wearing the automatic design device for XR-based MEP facility 1100. Here, a measurement value of the gyro sensor may be additionally considered when performing calibration of setting the current position (reference position) of the automatic design device for XR-based MEP facility 1100.

Also, the automatic design device for XR-based MEP facility 1100 may further include a user interface device with a button used for the user wearing the automatic design device for XR-based MEP facility 1100 to enter an instruction for manipulating the automatic design device for XR-based MEP facility 1100.

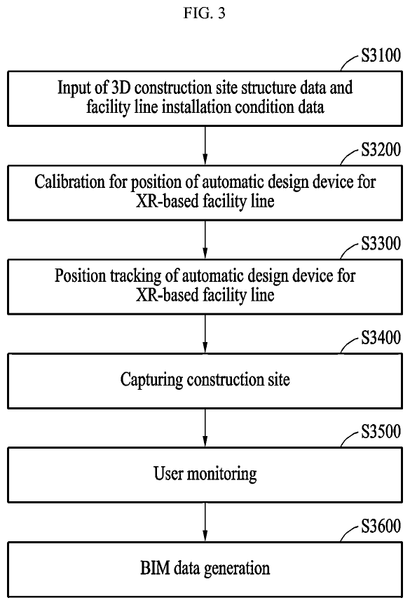

FIG. 3 illustrates an example of describing an operation of an automatic design device for XR-based MEP facility according to an example embodiment.

Hereinafter, description is made based on an example in which the method of FIG. 3 is performed by the automatic design device for XR-based MEP facility 1100 of FIG. 1.

In operation S3100, the automatic design device for XR-based MEP facility 1100 may receive, from an external device, data for automatically designing MEP facility, for example, 3D construction site structure data that includes structure and coordinate information of a construction site and MEP facility installation condition data that includes conditions for installing the MEP facility in the construction site, through a wired/wireless communication method.

In an example embodiment, the MEP facility may refer to facility desired to install in the construction site, such as pipeline, electrical cable line, communication cable line, and duct line.

In an example embodiment, the MEP facility installation condition data may represent conditions to be met in installing the MEP facility, such as a separation distance between MEP facilities, the allowable number of inflection points, and an allowable bending angle of MEP facility.

In operation S3200, the automatic design device for XR-based MEP facility 1100 may calibrate a position of the automatic design device for XR-based MEP facility 1100. In detail, when the automatic design device for XR-based MEP facility 1100 is present at a preset position of the construction site, the automatic design device for XR-based MEP facility 1100 may perform calibration of setting coordinates corresponding to the preset position in the 3D construction site structure data to a current position (reference position) of the automatic design device for XR-based MEP facility 1100 in the 3D construction site structure data. This is to minimize an error when installing the MEP facility by matching the position of the automatic design device for XR-based MEP facility 1100 to coordinates on the 3D construction site structure data.

In an example embodiment, when the automatic design device for XR-based MEP facility 1100 is present at the preset position of the construction site, it may represent that the automatic design device for XR-based MEP facility 1100 is combined with a beacon structure installed at the preset position. Here, the beacon structure may include a cradle configured to couple with the automatic design device for XR-based MEP facility 1100 in its upper portion.

In an example embodiment, a case in which the automatic design device for XR-based MEP facility 1100 is present at the preset position of the construction site may correspond to a case in which a marker containing coordinate information corresponding to the preset position in the 3D construction site structure data in a QR code or an image form is recognized. Here, a case in which the marker is recognized may represent that the marker is included in a video captured with a camera unit.

In operation S3300, the automatic design device for XR-based MEP facility 1100 may track a position of the automatic design device for XR-based MEP facility 1100 on coordinates of the 3D construction site structure data. In detail, in a situation in which calibration for the position of the automatic design device for XR-based MEP facility 1100 is performed, if a user wearing the automatic design device for XR-based MEP facility 1100 moves, the automatic design device for XR-based MEP facility 1100 may track the position of the automatic design device for XR-based MEP facility 1100 in the 3D construction site structure data. This is to update the position of the automatic design device for XR-based MEP facility 1100 in real time although the user wearing the automatic design device for XR-based MEP facility 1100 moves.

In an example embodiment, the automatic design device for XR-based MEP facility 1100 may periodically or aperiodically track a position of the automatic design device for XR-based MEP facility 1100 in the 3D construction site structure data. For example, at preset time intervals or every time a movement of the user is detected, the automatic design device for XR-based MEP facility 1100 may track a position of the automatic design device for XR-based MEP facility 1100 and may update position information of the automatic design device for XR-based MEP facility 1100.

In operation S3400, the automatic design device for XR-based MEP facility 1100 may generate a video by capturing the construction site and surroundings of the user such as a body of the user, from a viewpoint of the user wearing the automatic design device for XR-based MEP facility 1100.

Also, the automatic design device for XR-based MEP facility 1100 may generate and output a video of the same view as the user's real view based on a video captured by the camera unit and, to this end, may include a display (not shown). This is to allow the user wearing the automatic design device for XR-based MEP facility 1100 to view the video of the same view as the user's real view through the output unit 2700 of the automatic design device for XR-based MEP facility 1100.

In an example embodiment, the automatic design device for XR-based MEP facility 1100 may output a video with a menu for controlling the automatic design device for XR-based MEP facility 1100 and the generated virtual MEP facility added.

In operation S3500, the automatic design device for XR-based MEP facility 1100 may monitor the body of the user included in the video. Specifically, the automatic design device for XR-based MEP facility 1100 may verify whether the body of the user, such as a finger included in the video, includes a gesture of specifying a specific area. When the gesture of specifying the specific area is verified, the automatic design device for XR-based MEP facility 1100 may match the 3D construction site structure data and the video based on position tracking results and may verify coordinates in the 3D construction site structure data for an area indicated by the body of the user, such as the finger.

In an example embodiment, the automatic design device for XR-based MEP facility 1100 may verify an instruction from the user. In detail, when it is verified that a gesture prestored by being matched to a specific instruction is included in the video, the automatic design device for XR-based MEP facility 1100 may verify that the specific instruction is input from the user. Here, the specific instruction may include all instructions for the user to control the automatic design device for XR-based MEP facility 1100 to design the MEP facility, such as an instruction that specifies a starting point and an end point for installing the MEP facility.

In operation S3600, the automatic design device for XR-based MEP facility 1100 may generate BIM data that includes virtual design information on real MEP facility to be installed in the construction site. In detail, in response to an input of the instruction that specifies the starting point for installing the MEP facility, the automatic design device for XR-based MEP facility 1100 may verify coordinates of the area indicated by the body of the user in the 3D construction site structure data based on monitoring results (hereinafter, the coordinates being referred to as starting point coordinates). In response to an input of the instruction that specifies the ending point for installing the MEP facility, the automatic design device for XR-based MEP facility 1100 may verify coordinates of the area indicated by the body of the user in the 3D construction site structure data based on the monitoring results (hereinafter, the coordinates being referred to as ending point coordinates). The automatic design device for XR-based MEP facility 1100 may generate the virtual MEP facility that connects the starting point coordinates and the ending point coordinates based on the MEP facility installation condition data and may store the same as the BIM data.

In an example embodiment, the automatic design device for XR-based MEP facility 1100 may store BIM data in the form of an electronic document, such as PDF, including a design book that includes design information of the MEP facility and a statement that includes quantity information for installing the MEP facility.

In an example embodiment, when at least one virtual MEP facility is already generated and it is impossible to generate the virtual MEP facility that connects the starting point coordinates and the ending point coordinates based on the MEP facility installation condition data while avoiding the already generated virtual MEP, the automatic design device for XR-based MEP facility 1100 may modify data for the already generated virtual MEP facility based on the MEP facility installation condition data and may generate the data for the virtual MEP facility that connects the starting point coordinates and the ending point coordinates.

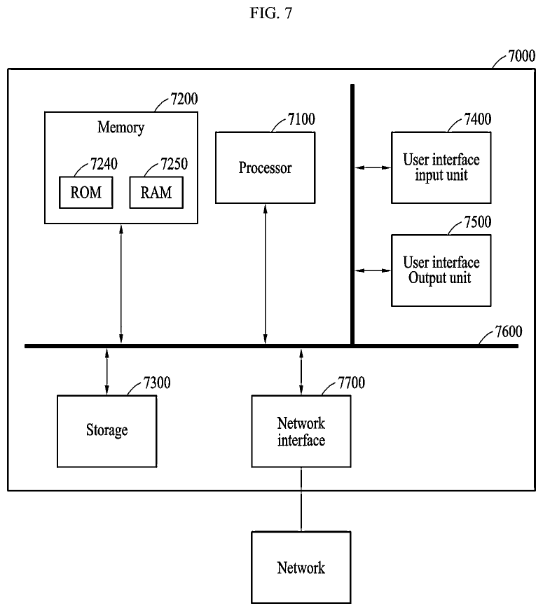

FIG. 7 is a block diagram illustrating an automatic design device for XR-based MEP facility according to another example embodiment.

As illustrated in FIG. 7, the automatic design device for XR-based MEP facility 7000 may include at least one component among a processor 7100, a memory 7200, a storage 7300, a user interface input unit 7400, and a user interface output unit 7500 and they may communicate with each other through a bus 7600. Also, the automatic design device for XR-based MEP facility 1100 may include a network interface 7700 for connection to a network. The processor 7100 may be a central processing unit (CPU) or a semiconductor device configured to execute a processing instruction stored in the memory 7200 and/or the storage 7300. The memory 7200 and the storage 7300 may include various types of volatile/nonvolatile recording media. For example, the memory 7200 may include read only memory (ROM) 7240 and random access memory (RAM) 7250.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. The processing device may run an operating system (OS) and one or more software applications that run on the OS.

The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a signal wave to be transmitted to be interpreted by the processing device or to provide an instruction or data to the processing device. The software also may be distributed over network coupled computer systems so that the software is stored and executed in a distributed fashion. The software and data may be stored by one or more computer readable storage media.

While the example embodiments are described with reference to specific example embodiments and drawings, it will be apparent to one of ordinary skill in the art that various changes and modifications in form and details may be made in these example embodiments from the description. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

| | |
|---|---|
| 1100: Automatic design device | |
| for XR-based MEP facility | |
| 2100: Communication unit | 2200: Calibration unit |
| 2300: Position tracking unit | 2400: Video capturing unit |
| 2500: User monitoring unit | 2600: BIM data generator |
| 2700: Output unit | |

What is claimed is:

1. An automatic design device for extended reality (XR)-based mechanical, electrical and plumbing (MEP) facility, comprising:
a position calibration unit configured to, when the automatic design device for XR-based MEP facility is present at a preset position of a construction site, calibrate coordinates corresponding to the preset position in three-dimensional (3D) construction site structure data that includes structure and coordinate information of the construction site to a current position of the automatic design device for XR-based MEP facility in the 3D construction site structure data; and
a position tracking unit configured to track a position of the automatic design device for XR-based MEP facility in the 3D construction site structure data based on the current position when a user wearing the automatic design device for XR-based MEP facility moves.

2. The automatic design device for XR-based MEP facility of claim 1, further comprising:
a video capturing unit configured to capture a video that includes the construction site and a body of the user from a viewpoint of the user;
a user monitoring unit configured to match the 3D construction site structure data and the video based on position tracking results and to monitor coordinates of an area indicated by the body of the user in the 3D construction site structure data; and
a building information modeling (BIM) data generator configured to verify the coordinates of the area indicated by the body of the user in the 3D construction site structure data based on monitoring results in response to an input of an instruction that specifies a starting point for installing the MEP facility, the coordinates being referred to as starting point coordinates, to verify the coordinates of the area indicated by the body of the user in the 3D construction site structure data based on the monitoring results in response to an input of an instruction that specifies an ending point for installing the MEP facility, the coordinates being referred to as ending point coordinates, and to generate data for virtual MEP facility that connects the starting point coordinates and the ending point coordinates based on MEP facility installation condition data that includes conditions for installing the MEP facility in the construction site.

3. The automatic design device for XR-based MEP facility of claim 2, wherein the BIM data generator is configured to generate BIM data based on data for the generated MEP facility and to generate a drawing, a statement, and a design book for designing the MEP facility based on the generated BIM data.

4. The automatic design device for XR-based MEP facility of claim 2, further comprising:
a communication unit configured to receive the 3D construction site structure data and the MEP facility installation condition data.

5. The automatic design device for XR-based MEP facility of claim 1, wherein, when the automatic design device for XR-based MEP facility is present at the preset position of the construction site, the automatic design device for XR-based MEP facility is configured to combine with a beacon structure installed at the preset position.

6. The automatic design device for XR-based MEP facility of claim 1, wherein a case in which the automatic design device for XR-based MEP facility is present at the preset position of the construction site corresponds to a case in which a marker containing coordinate information corresponding to the preset position in the 3D construction site structure data in a quick response (QR) code or an image form is recognized.

7. The automatic design device for XR-based MEP facility of claim 2, wherein the MEP facility includes at least one of pipeline, electrical cable line, communication cable line, and duct line.

8. The automatic design device for XR-based MEP facility of claim 2, wherein the MEP facility installation condition data includes at least one of a separation distance between MEP facilities, the allowable number of inflection points, and an allowable bending angle of MEP facility.

9. The automatic design device for XR-based MEP facility of claim 2, wherein the area indicated by the body of the user represents an area indicated by a finger in the body of the user.

10. The automatic design device for XR-based MEP facility of claim 2, wherein the BIM data generator is configured to, when at least one virtual MEP facility is already generated and it is impossible to generate the virtual MEP facility that connects the starting point coordinates and the ending point coordinates based on the MEP facility installation condition data while avoiding the already generated virtual MEP facility, modify data for the already generated virtual MEP facility based on the MEP facility installation condition data and to generate the data for the virtual MEP facility that connects the starting point coordinates and the ending point coordinates.

11. A method performed by an automatic design device for extended reality (XR)-based mechanical, electrical and plumbing (MEP) facility, the method comprising:
when the automatic design device for XR-based MEP facility is present at a preset position of a construction site, calibrating coordinates corresponding to the preset position in three-dimensional (3D) construction site structure data that includes structure and coordinate information of the construction site to a current position of the automatic design device for XR-based MEP facility in the 3D construction site structure data; and
tracking a position of the automatic design device for XR-based MEP facility in the 3D construction site structure data based on the current position when a user wearing the automatic design device for XR-based MEP facility moves.

12. The method of claim 11, further comprising:
capturing a video that includes the construction site and a body of the user from a viewpoint of the user;
verifying the coordinates of the area indicated by the body of the user in the 3D construction site structure data in response to an input of an instruction that specifies a starting point for installing the MEP facility, the coordinates being referred to as starting point coordinates; and
verifying the coordinates of the area indicated by the body of the user in the 3D construction site structure data in response to an input of an instruction that specifies an ending point for installing the MEP facility, the coordinates being referred to as ending point coordinates; and
generating data for virtual MEP facility that connects the starting point coordinates and the ending point coordinates based on the MEP facility installation condition data.

13. The method of claim 12, further comprising:
generating building information modeling (BIM) data based on data for the generated MEP facility and generating a drawing, a statement, and a design book for designing the MEP facility based on the generated BIM data.

14. The method of claim 12, further comprising:
receiving the 3D construction site structure data and the MEP facility installation condition data.

15. The method of claim 11, wherein, when the automatic design device for XR-based MEP facility is present at the preset position of the construction site, the automatic design device for XR-based MEP facility is configured to combine with a beacon structure installed at the preset position.

16. The method of claim 11, wherein a case in which the automatic design device for XR-based MEP facility is present at the preset position of the construction site corresponds to a case in which a marker containing coordinate information corresponding to the preset position in the 3D construction site structure data in a quick response (QR) code or an image form is recognized.

17. The method of claim 12, wherein the MEP facility includes at least one of pipeline, electrical cable line, communication cable line, and duct line.

18. The method of claim 12, wherein the MEP facility installation condition data includes at least one of a separation distance between MEP facilities, the allowable number of inflection points, and an allowable bending angle of MEP facility.

19. The method of claim 12, wherein the area indicated by the body of the user represents an area indicated by a finger in the body of the user.

20. The method of claim 12, wherein the generating of the data for the virtual MEP facility comprises, when at least one virtual MEP facility is already generated and it is impossible to generate the virtual MEP facility that connects the starting point coordinates and the ending point coordinates based on the MEP facility installation condition data while avoiding the already generated virtual MEP facility, modifying data for the already generated virtual MEP facility based on the MEP facility installation condition data and generating the data for the virtual MEP facility that connects the starting point coordinates and the ending point coordinates.
